(19) United States
(12) Patent Application Publication
(10) Pub. No.: US 2026/0301707 A1
(43) Pub. Date: Oct. 1, 2026

(54) DISPLAY DEVICE, METHOD FOR DRIVING DISPLAY DEVICE, AND ELECTRONIC APPARATUS

(71) Applicants: Sharp Display Technology Corporation, Kameyama City (JP); SHARP KABUSHIKI KAISHA, Osaka (JP)

(72) Inventors: Kohji SAITOH, Kameyama City (JP); Tatsuya HAYASHI, Kameyama City (JP); Shunsuke ISHII, Osaka (JP); DAIJI KITAGAWA, Osaka (JP)

(21) Appl. No.: 19/576,366

(22) Filed: Mar. 24, 2026

(30) Foreign Application Priority Data
Mar. 31, 2025 (JP) 2025-059658

(51) Int. Cl. G09G 3/36

(52) U.S. Cl. CPC G09G 3/3688; G09G 3/3677; G09G 2310/0245; G09G 2320/0247; G09G 2320/046; G09G 2330/023

(57) ABSTRACT

A source drive circuit effects alternate current driving of a polarity of a source signal that is supplied to a source bus line. A control circuit controls a gate drive circuit and the source drive circuit so that in a partial area, a pixel voltage is supplied at a first refresh rate and so that in an area other than the partial area, the pixel voltage is supplied at a second refresh rate that is lower than the first refresh rate and that is a frequency of a fraction of an odd number-th of the first refresh rate.

### BACKGROUND

### 1. Field

The present disclosure relates to a display device, a method for driving a display device, and an electronic apparatus.

### 2. Description of the Related Art

Japanese Unexamined Patent Application Publication No. 2008-185996 discloses a configuration in which a liquid crystal display panel is driven to perform a display. In this configuration, during partial driving in which part of the liquid crystal display panel serves as a non-display region and the remaining part of liquid crystal display panel serves as a display region, a refresh operation of the non-display region is performed every plurality of frame periods. In a frame period during which a refresh operation of the display region is not performed, only a period during which to scan the display region is had while one frame period is kept a certain period of time. In correspondence with this, the number of times the polarity of a counter electrode driving signal VCOM is inverted is made smaller than the number of times the refresh operation of the non-display region is performed in a frame period, so that power consumption is reduced.

Japanese Unexamined Patent Application Publication No. 2008-185996 is specialized in a power consumption reducing technique in a liquid crystal panel whose polarity inversion is a line inversion technique, and makes no mention of the association between the input frequency of incoming video data and an actual panel refresh rate.

In a display device in which a plurality of refresh rates are spatially and temporally mixed, performing polarity inversion driving corresponding to the refresh rates causes there to occur a phenomenon in which the liquid crystals are subjected to only a biased polarity, causing there to occur burn-in and flickering. Even with the use of the technology disclosed in Japanese Unexamined Patent Application Publication No. 2008-185996, such a problem is not addressable.

It is desirable to provide a technology for reducing the occurrence of burn-in or flickering even in a case where a display is performed at a plurality of refresh rates.

### SUMMARY

According to an aspect of the disclosure, there is provided a display device including a display panel including a pixel electrode and a common electrode that forms an electric field with the pixel electrode, a gate drive circuit that supplies a gate signal to a gate bus line of the display panel, a source drive circuit that supplies a pixel voltage to the pixel electrode by sequentially supplying a source signal to a source bus line of the display panel, and a control circuit that controls a refresh rate that is a frequency at which an image displayed on the display panel is rewritten. The source drive circuit effects alternate current driving of a polarity of a source signal that is supplied to the source bus line. The control circuit controls the gate drive circuit and the source drive circuit so that in a partial area, the pixel voltage is supplied at a first refresh rate and so that in an area other than the partial area, the pixel voltage is supplied at a second refresh rate that is lower than the first refresh rate and that is a frequency of a fraction of an odd number-th of the first refresh rate.

According to an aspect of the disclosure, there is provided a display device including a display panel including a pixel electrode and a common electrode that forms an electric field with the pixel electrode, a gate drive circuit that supplies a gate signal to a gate bus line of the display panel, a source drive circuit that supplies a pixel voltage to the pixel electrode by sequentially supplying a source signal to a source bus line of the display panel, and a control circuit that controls a refresh rate that is a frequency at which an image displayed on the display panel is rewritten. The source drive circuit effects alternate current driving of a polarity of a source signal that is supplied to the source bus line. The control circuit controls the gate drive circuit and the source drive circuit so that in a partial area, the pixel voltage is supplied at a first refresh rate and so that in an area other than the partial area, the pixel voltage is supplied at a second refresh rate that is lower than the first refresh rate and at which a polarity of the source signal is subjected to alternate current driving.

### BRIEF DESCRIPTION OF THE DRAWINGS

FIG. 1 is a diagram for explaining the principle of a display method in a display device in which a plurality of refresh rates are mixed;

FIG. 2 is a diagram for explaining the principle of a display method in a display device in which a plurality of refresh rates are mixed;

FIG. 3 is a diagram showing an example configuration of a display device according to an embodiment of the present disclosure;

FIG. 4 is a circuit diagram showing a configuration of a pixel;

FIG. 5 is a block diagram showing an example configuration of a control circuit of the display device according to the embodiment of the present disclosure;

FIG. 6 is a diagram for explaining changes in data stored in RAM;

FIG. 7 is a diagram for explaining a polarity inversion driving method for the display device according to the embodiment of the present disclosure;

FIG. 8 is a block diagram showing an example configuration of a control circuit of a display device according to an embodiment of the present disclosure;

FIG. 9 is a diagram for explaining a polarity inversion driving method for the display device according to the embodiment of the present disclosure; and

FIG. 10 is a block diagram showing an example configuration of a control circuit of a display device according to an embodiment of the present disclosure.

### DESCRIPTION OF THE EMBODIMENTS

The following gives a detailed description of an embodiment of the present disclosure with reference to the drawings. In a description of the drawings, identical components or substantially identical components are given identical reference signs, and a detailed description of such components is not repeated.

### First Embodiment

A notebook PC (personal computer) or other computers are not only used in a full-screen mode but also very often used in a window mode during which movie content is displayed in only part of the screen and still image content is displayed in the other parts. Not only during display of movie content but also during use in business, document software, spreadsheet software, or other software is often used in a state where a display in part of the screen is updated and substantially the same screen continues to be displayed in the other areas.

There has been a limit to reducing the amount of electricity that is consumed by a notebook PC that is often used in such a way, as the whole area has conventionally been updated (panel: gate bus line scanning) even in a case where a display in part of the screen is updated. However, power consumption has recently been reduced by providing areas of different refresh rates within the screen.

However, in the case of a liquid crystal display, there is a need to perform alternate current driving in which the polarity of a voltage that is applied to the liquid crystals are inverted from positive polarity to negative polarity, and vice versa. To address this need, it is desirable to provide a liquid crystal display in which all areas are subjected to alternate current driving by controlling the frequency of incoming partial area data so that the other areas are controlled in a fraction of an odd number-th of the frequency. Principle of Display Method in Display Device in Which Plurality of Refresh Rates Are Mixed

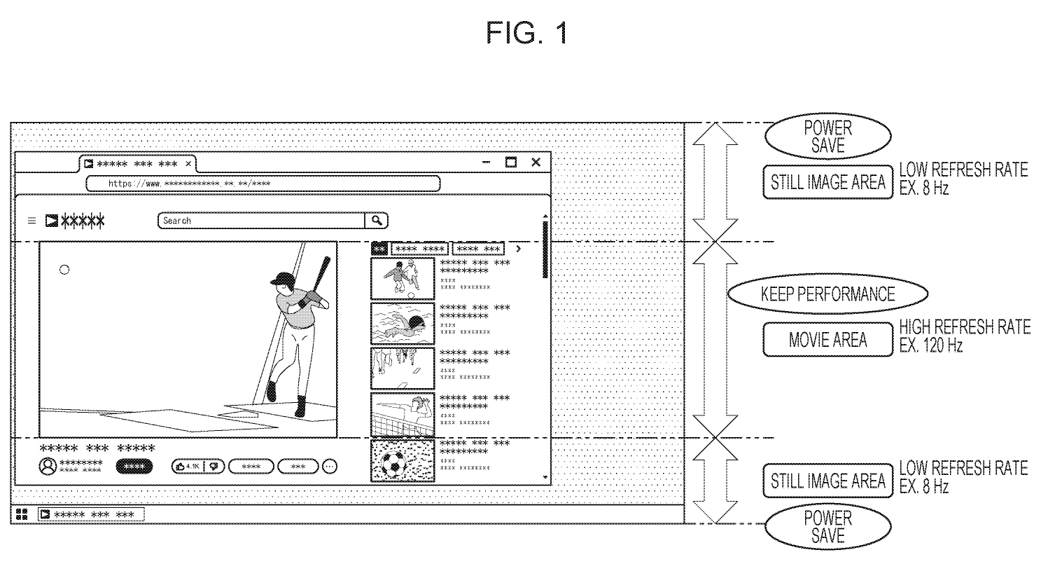

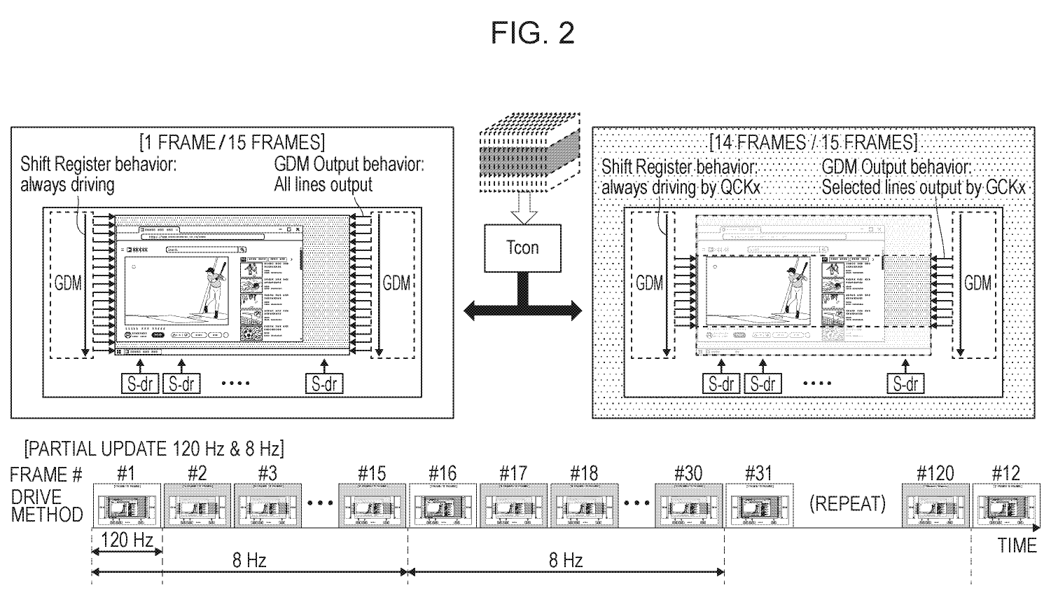

First, the principle of a display method in a display device in which a plurality of refresh rates are mixed is illustrated. FIGS. 1 and 2 are diagrams for illustrating the principle of a display method in a display device in which a plurality of refresh rates are mixed.

As shown in FIG. 1, for example, the display area is divided into three areas. The upper area is a still image area and, for example, is refreshed at a low refresh rate of 8 Hz. Since the refresh rate is low in frequency, a display with low power consumption (Power Save) is possible. In the present embodiment, part of the display area that is relatively high in frequency of the refresh rate is called "partial area", and the other parts of the display area that are lower in refresh rate than the partial area are called "other areas".

The central area is a movie area and, for example, is refreshed at a high refresh rate of 120 Hz. Since the refresh rate is high in frequency, display performance is kept (Keep Performance).

The lower area is a still image area and, for example, is refreshed at a low refresh rate of 8 Hz. Since the refresh rate is low in frequency, a display with low power consumption (Power Save) is possible.

As shown in FIG. 2, the refresh rates are controlled by a control circuit (Tcon (timing controller)). As shown in the upper left part of FIG. 2, an image in the whole area is refreshed only once in fifteen frames. As shown in the lower part of FIG. 2, the image in the whole area is refreshed in the frames #1, #16, #31, .... As a result of that, the whole area is refreshed at a low refresh rate of 8 Hz.

As shown in the upper right part of FIG. 2, an image in the movie area is refreshed fourteen times in fifteen frames. As shown in the lower part of FIG. 2, the image in the movie area is refreshed in the frames #2 to #15, #17 to #30, #32 to #45, .... As a result of that, the movie area is refreshed at a high refresh rate of 120 Hz.

### Example Configuration of Display Device

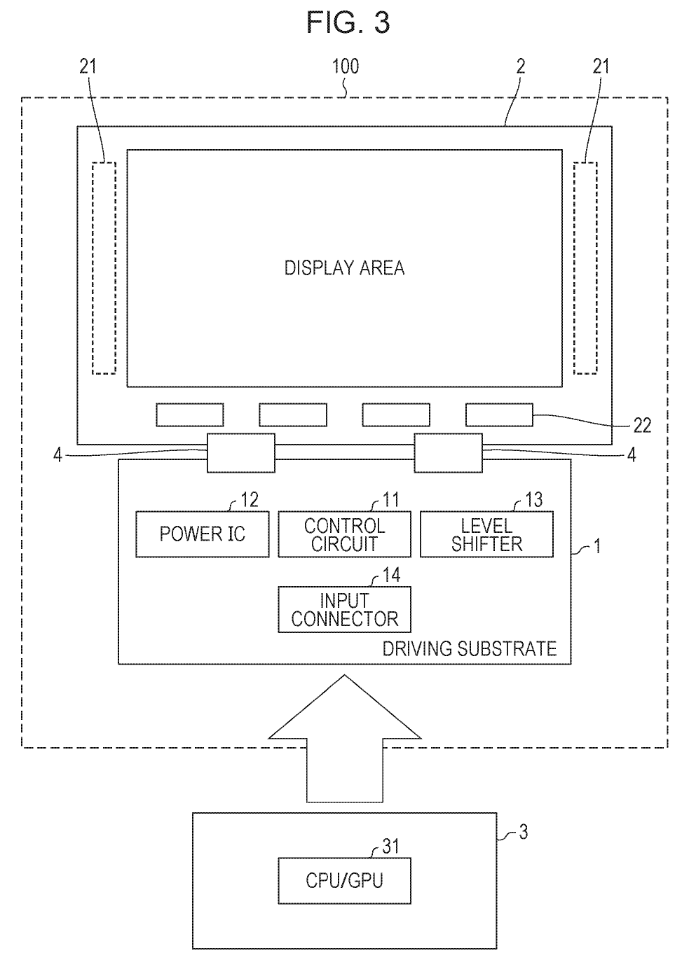

FIG. 3 is a diagram showing an example configuration of a display device according to an embodiment of the present disclosure. As shown in FIG. 3, the display device 100 includes a driving substrate 1, a display panel 2, and an FPC 4. An apparatus including the display device 100 and a PC system side motherboard 3 is called "electronic apparatus".

The display device 100 is, for example, a display monitor, a personal computer, a tablet terminal, a smartphone, a smartwatch, or a television device. Further, the display device 100 is, for example, a liquid crystal display. The driving substrate 1 may be configured as a device integrated with the display device 100 or may be configured as a device separate from the display device 100.

Further, the display device 100 may be driven by any driving method such as an FFS (fringe field switching) method, an IPS (in-plane switching) method, a TN (twisted nematic) method, or a VA (vertical alignment) method. Although the following illustrates a case where the display device 100 is a liquid crystal display device, this is not intended to impose any limitation.

The display panel 2 includes a gate drive circuit 21, a source drive circuit 22, a plurality of gate lines, and a plurality of source lines. The gate drive circuit 21 supplies a gate signal to a gate bus line of the display panel 2. The source drive circuit 22 supplies a pixel voltage to a pixel electrode by sequentially supplying a source signal to a source bus line of the display panel 2.

The number of gate lines is a natural number m. The number of source lines is a natural number n. The plurality of gate lines are disposed to cross the plurality of source lines. As one example, a case is described where the display panel 2 employs alternate current driving in which the display panel 2 is driven with the polarity inverted every frame period. Therefore, the source drive circuit 22 inverts the polarity of a source signal that is supplied to a source bus line.

It is not imperative that the inversion of positive and negative polarities be necessarily executed alternately every frame. Inversion may occur every plurality of frames, or writing of the same polarity may occur in succession to correct an imbalance in polarity. In so doing, the full-screen area needs only be updated in a fraction of an odd number-th on a frame-by-frame basis.

The inversion of positive and negative polarities does not necessarily occur at a constant frequency. This is because a notebook PC is frequently put in a situation where input video data is not inputted except for a certain period. Even in this case, the partial area and the other areas are driven basically as many times as a fraction of an odd number-th.

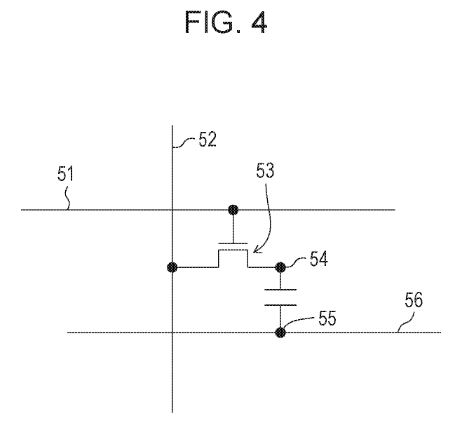

FIG. 4 is a circuit diagram showing a configuration of a pixel. The display panel 2 includes a pixel electrode 54 and a common electrode that forms an electric field with the pixel electrode 54. As shown in FIG. 4, a thin-film transistor 53 and the pixel electrode 54 are placed in a region (pixel) demarcated by a plurality of gate bus lines 51 and a plurality of source bus lines 52. A gate bus line 51 is connected to a gate electrode of the thin-film transistor 53. A source bus line 52 is connected to a source electrode of the thin-film transistor 53.

The pixel electrode 54 is connected to a drain electrode of the thin-film transistor 53. The display panel 2 is provided with a common electrode 55 that forms an electric field with the pixel electrode 54. The common electrode 55 is placed in correspondence with (provided in common for) a plurality of the pixel electrodes 54. The display panel 2 is provided with a common wire 56 that connects the common electrode 55 with the driving substrate 1.

A multicolor display can be performed by transmitting light from a BL (not illustrated) provided behind the display panel 2 depending on a state of transmission of pixel TFTs that are driven by the gate drive circuit 21 and the source drive circuit 22 or by using a color filter and a BM (black matrix) placed on one of two glass substrates between which the liquid crystals are sandwiched that is free from drive bus lines or source bus lines.

The driving substrate 1 includes a control circuit (Tcon) 11, a power IC (integrated circuit) 12, and a level shifter circuit 13. The power IC 12 generates, from a voltage of 3.3 V supplied from the PC system side motherboard 3, a voltage that is used for driving in the display device 100.

The control circuit 11 generates, on the basis of a video signal outputted from the PC system side motherboard 3, a signal that is used to drive the gate drive circuit 21 and the source drive circuit 22 and outputs the signal. Further, the control circuit 11 controls a refresh rate that is a frequency at which an image displayed on the display panel 2 is rewritten. The control circuit 11 will be described in detail later.

The level shifter circuit 13 converts a signal outputted from the control circuit (Tcon) 11 for controlling the gate drive circuit 21 into such a voltage level as to be able to be driven by the gate drive circuit 21 built in glass and outputs the signal thus converted. Further, the level shifter circuit 13 may also generate a signal that is not outputted from the control circuit 11 and that is used in the gate drive circuit 21.

The PC system side motherboard 3 is mounted with a CPU (central processing unit) or a GPU (graphical processing unit) 31 and supplies the display device 100 with image data corresponding to the partial area and image data corresponding to the entire screen. The PC system side motherboard 3 outputs full-screen data to the control circuit 11 in a case where the full-screen data has been updated and outputs only partial area data to the control circuit 11 in a case where only the partial area data has been updated.

The FPC (flexible printed circuit) 4 is a component for connecting the driving substrate 1 with the display panel 2 to supply power and various signals generated by the driving substrate 1 to the gate drive circuit 21 and the source drive circuit 22 mounted in the display panel 2.

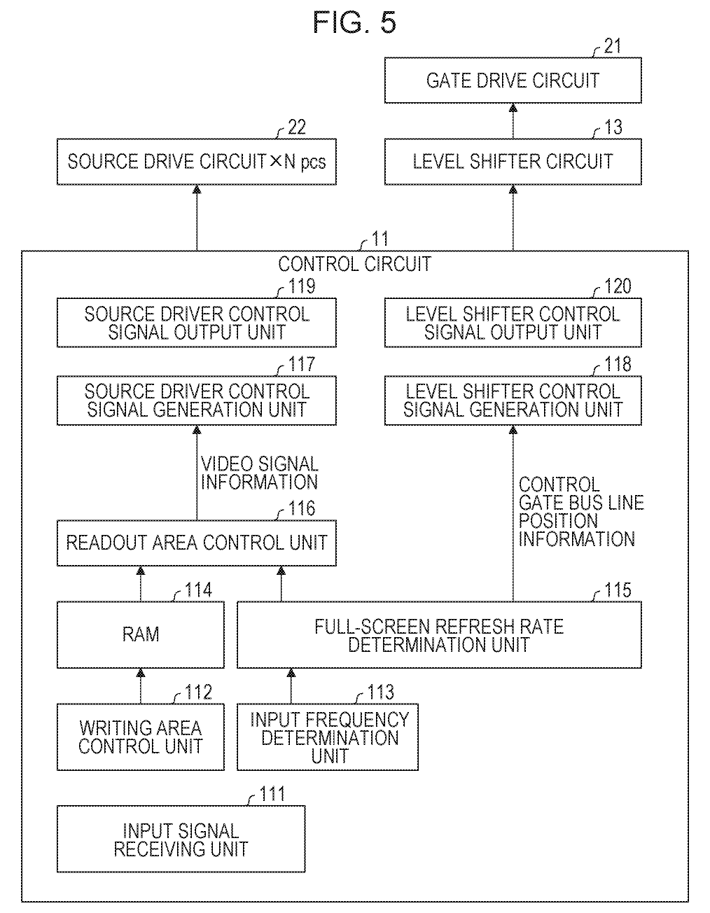

FIG. 5 is a block diagram showing an example configuration of the control circuit 11 of the display device 100 according to the embodiment of the present disclosure. The control circuit 11 controls the gate drive circuit 21 and the source drive circuit 22 so that a pixel electrode corresponding to the partial area is supplied with the pixel voltage at a high refresh rate (first refresh rate).

Further, the control circuit 11 controls the gate drive circuit 21 and the source drive circuit 22 so that a pixel electrode corresponding to an area other than the partial area is supplied with the pixel voltage at a low refresh rate (second refresh rate) that is lower than the high refresh rate (first refresh rate) and at which the polarity of a source signal is alternately inverted from positive polarity to negative polarity, and vice versa.

As shown in FIG. 5, the control circuit 11 includes an input signal receiving unit 111, a writing area control unit 112, an input frequency determination unit 113, a RAM (random-access memory) 114, a full-screen refresh rate determination unit 115, a readout area control unit 116, a source driver control signal generation unit 117, a level shifter control signal generation unit 118, a source driver control signal output unit 119, and a level shifter control signal output unit 120.

The input signal receiving unit 111 receives the full-screen data or the partial area data as an input signal from the PC system side motherboard 3 via an input connector 14. The input signal receiving unit 111 receives the full-screen data in a case where the full-screen data has been updated and receives only the partial area data in a case where only the partial area data has been updated.

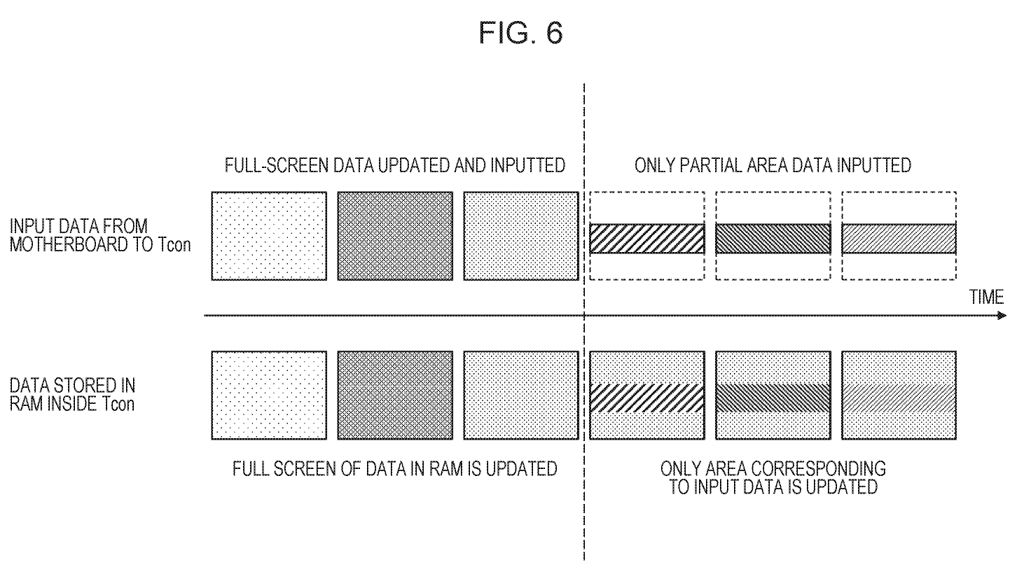

The writing area control unit 112 writes, to an appropriate region in the RAM 114, the full-screen data or the partial area data received from the PC system side motherboard 3. As shown in FIG. 6, the writing area control unit 112 updates a full screen of display data in the RAM 114 in a case where the writing area control unit 112 has received the full-screen data from the PC system side motherboard 3. Further, the writing area control unit 112 updates the area's display data in the RAM 114 in a case where the writing area control unit 112 has received the partial area data from the PC system side motherboard 3.

The input frequency determination unit 113 determines the frequency (input frequency) of the high refresh rate. As mentioned above, the high refresh rate is a frequency at which the movie area is refreshed, and is, for example, 120 Hz.

The full-screen refresh rate determination unit 115 determines the frequency of a full-screen refresh rate. As mentioned above, the full-screen refresh rate (second refresh rate) is a frequency at which the entire screen (still image areas + movie area) is refreshed, and is determined as a frequency of a fraction of an odd number-th of the input frequency (first refresh rate). Examples of the full-screen refresh rate include 40 Hz, which is a frequency of 1/3 of the input frequency, and 24 Hz, which is a frequency of 1/5 of the input frequency.

Further, the full-screen refresh rate determination unit 115 determines an area to be refreshed at the high refresh rate and outputs the area to the readout area control unit 116 and the level shifter control signal generation unit 118. The full-screen refresh rate determination unit 115 outputs, to the readout area control unit 116, a region in the RAM 114 in which the partial area data is stored. Further, the full-screen refresh rate determination unit 115 outputs, to the level shifter control signal generation unit 118, position information (control gate bus line position information) of a gate bus line corresponding to the partial area.

The readout area control unit 116 reads out the full-screen data or the partial area data from the RAM 114 and outputs the full-screen data or the partial area data as a video information signal to the source driver control signal generation unit 117. In a case where a frame corresponding to the high refresh rate is displayed on the display panel 2, the readout area control unit 116 reads out only the partial area data from the RAM 114 and outputs the partial area data to the source driver control signal generation unit 117. Further, in a case where a frame corresponding to the low refresh rate is displayed on the display panel 2, the readout area control unit 116 reads out the full-screen data from the RAM 114 and outputs the full-screen data to the source driver control signal generation unit 117.

The source driver control signal generation unit 117 generates, in accordance with the video information signal outputted from the readout area control unit 116, a control signal (source driver control signal) that is outputted to the source drive circuit 22, and outputs the source driver control signal to the source driver control signal output unit 119.

The source driver control signal output unit 119 outputs, to the source drive circuit 22, the source driver control signal generated by source driver control signal generation unit 117. As mentioned above, the source drive circuit 22 inverts the polarity of a source signal that is supplied to a source bus line.

The level shifter control signal generation unit 118 generates, in accordance with the control gate bus line position information outputted from the full-screen refresh rate determination unit 115, a control signal (level shifter control signal) for controlling the level shifter circuit 13, and outputs the level shifter control signal to the level shifter control signal output unit 120.

The level shifter control signal output unit 120 outputs, to the level shifter circuit 13, the level shifter control signal generated by the level shifter control signal generation unit 118. In a case where a frame corresponding to the high refresh rate is displayed, the level shifter control signal output unit 120 outputs, to the level shifter circuit 13, only a level shifter control signal corresponding to the partial area.

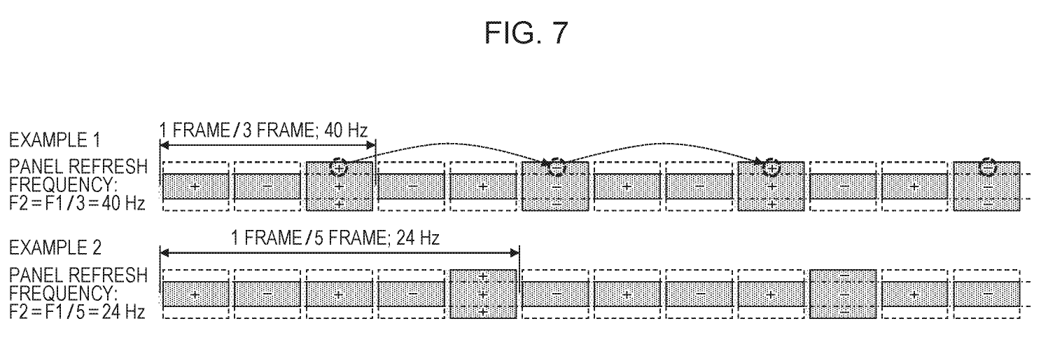

FIG. 7 is a diagram for explaining a polarity inversion driving method for the display device 100 according to the embodiment of the present disclosure. In Example 1 of FIG. 7, the frequency (F1) of the high refresh rate is 120 Hz, and the frequency (F2) of the low refresh rate is 40 Hz. The leftmost frame is the first frame followed by the second frame, the third frame, ....

In the first frame, only the partial area is refreshed, and driving is performed with positive polarity. Also in the second frame, only the partial area is refreshed, and driving is performed with negative polarity. In the third frame, the entire screen is refreshed, and driving is performed with positive polarity.

In the fourth frame, only the partial area is refreshed, and driving is performed with negative polarity. Also in the fifth frame, only the partial area is refreshed, and driving is performed with positive polarity. In the sixth frame, the entire screen is refreshed, and driving is performed with negative polarity.

Thus, in a frame corresponding to the high refresh rate (120 Hz), positive polarity driving and negative polarity driving are alternately performed, and also in a frame corresponding to the low refresh rate (40 Hz), positive polarity driving and negative polarity driving are alternately performed.

In Example 2 of FIG. 7, the frequency (F1) of the high refresh rate is 120 Hz, and the frequency (F2) of the low refresh rate is 24 Hz. The leftmost frame is the first frame followed by the second frame, the third frame, ....

In the first to fourth frames, only the partial area is refreshed, and positive polarity driving and negative polarity driving are alternately performed. In the fifth frame, the entire screen is refreshed, and driving is performed with positive polarity.

In the sixth to ninth frames, only the partial area is refreshed, and negative polarity driving and positive polarity driving are alternately performed. In the tenth frame, the entire screen is refreshed, and driving is performed with negative polarity.

Thus, in a frame corresponding to the high refresh rate (120 Hz), positive polarity driving and negative polarity driving are alternately performed, and also in a frame corresponding to the low refresh rate (24 Hz), positive polarity driving and negative polarity driving are alternately performed.

### Working Effects

As described above, the embodiment of the present disclosure brings about the following working effects.

In the display device 100, which uses a polarity inversion driving method in which the polarity of a source signal that is supplied to a source bus line is inverted every frame period, the control circuit 11 refreshes only the partial area in a case where a frame corresponding to the high refresh rate is displayed on the display panel 2. Further, the control circuit 11 refreshes the full-screen area in a case where a frame corresponding to the low refresh rate is displayed on the display panel 2. Further, the frequency of the low refresh rate is a fraction of an odd number-th of the frequency of the high refresh rate. With this, in the frame corresponding to the high refresh rate, positive polarity driving and negative polarity driving are alternately performed, and also in the frame corresponding to the low refresh rate, positive polarity driving and negative polarity driving are alternately performed. This makes it possible to reduce the occurrence of burn-in or flickering even in a case where a display is performed at a plurality of refresh rates.

### Second Embodiment

In actuality, an attempt to work out only with a certain fixed odd value in using a display device as a notebook PC may make a power consumption reducing effect insufficient or may result in burn-in or flickering. A reason for this is that in the notebook PC, unlike in a television, there are variations in input frequency depending on the content to be displayed or other factors. For example, motion picture content is usually at 24 Hz, and in cases such as live streams of sports such as soccer, high frequencies such as 120 Hz add to a you-are-there feeling. In cases such as YouTube (registered trademark), the input frequencies may be determined according to the specifications of a producer's camera, the specifications of an editing PC, or other factors.

Further, liquid crystal displays each have a minimum refresh rate set at the discretion of their respective manufacturers, which also contributes to variations in the minimum refresh rate of the displays. This makes it possible to, by selecting a maximum odd number that does not fall below this minimum refresh rate set value, achieve driving in which a plurality of refresh rates are mixed, with the power consumption reducing effect high and with display quality kept.

For example, let it be assumed that the low refresh rate is determined with the fixed odd number set to 3, which is smallest but 1, and the liquid crystal display has a minimum refresh rate F3 = 8 Hz. In this case, assuming that the input frequency F1 = 120 Hz, the frequency F2 of the low refresh rate is 40 Hz. Further, assuming that the input frequency F1 = 60 Hz, the frequency F2 of the low refresh rate is 20 Hz. Further, assuming that the input frequency F1 = 24 Hz, the frequency F2 of the low refresh rate is 8 Hz.

In each case, the minimum refresh rate F3 is not underrun, so that there occurs no failure. However, at the input frequency F1 = 120 Hz, the frequency of the low refresh rate is 40 Hz, with the result that contribution to power consumption reduction is insufficient.

Further, let it be assumed that the low refresh rate is determined with the fixed odd number set to 15 and the liquid crystal display has a minimum refresh rate F3 = 8 Hz. In this case, assuming that the input frequency F1 = 120 Hz, the frequency F2 of the low refresh rate is 8 Hz. Further, assuming that the input frequency F1 = 60 Hz, the frequency F2 of the low refresh rate is 4 Hz. Further, assuming that the input frequency F1 = 24 Hz, the frequency F2 of the low refresh rate is 1.6 Hz.

At the input frequency F1 = 120 Hz, the power consumption reducing effect is greater than in a case where the fixed odd number is 3. However, at F1 = 60 Hz and F1 = 24 Hz, the minimum refresh rate of the liquid crystal display is underrun. This may potentially cause burn-in or flickering.

Further, in a case where the low refresh rate assumes a numerical value obtained as a result of dividing the input frequency by the maximum odd number (odd number that is a positive integer) that does not fall below the minimum refresh rate F3 = 8 Hz of the liquid crystal display, the fixed odd number is 15 and the frequency F2 of the low refresh rate is 8 Hz at the input frequency F1 = 120 Hz. Further, the fixed odd number is 7 and the frequency F2 of the low refresh rate is 8.6 Hz at the input frequency F1 = 60 Hz. Further, the fixed odd number is 3 and the frequency F2 of the low refresh rate is 8 Hz at the input frequency F1 = 24 Hz.

In all cases, the power consumption reducing effect is enhanced with the frequency of the low refresh rate around 8 Hz. At the same time, since the minimum refresh rate of the liquid crystal display is not underrun, display quality is not affected. This raises the need for a procedure through which to increment odd values from the smallest value according to the input frequency F1, find the maximum numerical value while ensuring that F2 does not fall below F3, and adopt the numerical value thus found.

### Example Configuration of Display Device

A display device according to an embodiment of the present disclosure differs only in control circuit configuration from the example configuration of the display device 100 according to the first embodiment. In the following description, the control circuit according to the present embodiment is denoted by reference sign 11A.

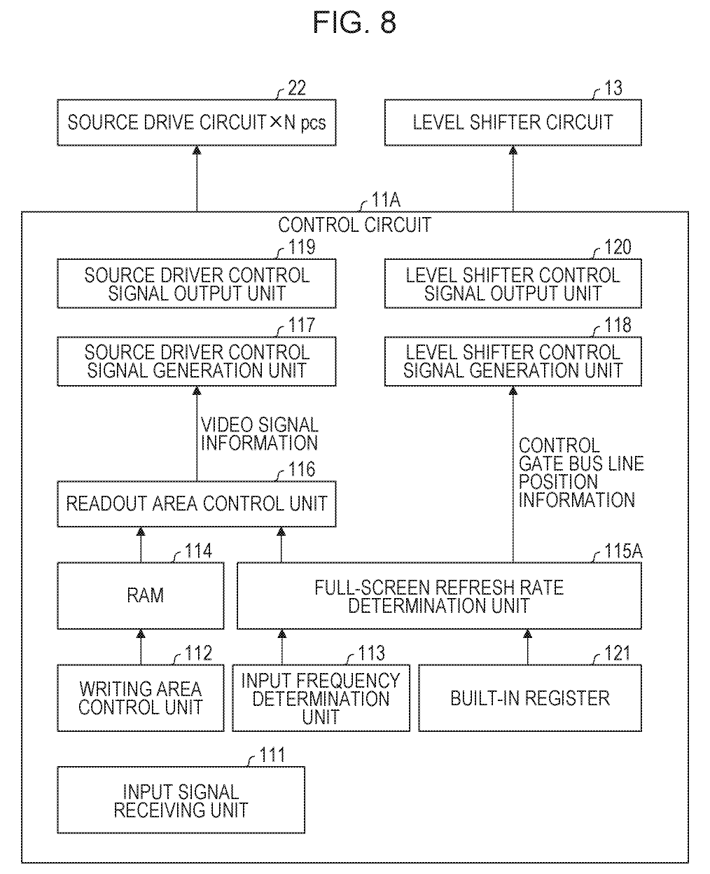

FIG. 8 is a block diagram showing an example configuration of the control circuit 11A of the display device 100 according to the embodiment of the present disclosure. As shown in FIG. 8, the control circuit 11A includes an input signal receiving unit 111, a writing area control unit 112, an input frequency determination unit 113, a RAM (random-access memory) 114, a full-screen refresh rate determination unit 115A, a readout area control unit 116, a source driver control signal generation unit 117, a level shifter control signal generation unit 118, a source driver control signal output unit 119, a level shifter control signal output unit 120, and a built-in register 121.

The built-in register 121 retains a set value of a minimum refresh rate (first predetermined refresh rate). For example, the description assumes that 8 Hz is set as the set value of the minimum refresh rate in the built-in register 121.

The full-screen refresh rate determination unit 115A determines, as the full-screen refresh rate, a numerical value obtained as a result of dividing the input frequency by a maximum odd number that does not fall below the minimum refresh rate stored in the built-in register 121. In a case where the set value of the minimum refresh rate is 8 Hz, the maximum odd number is 15; therefore, the full-screen refresh rate determination unit 115A determines that the frequency of the full-screen refresh rate is 8 Hz.

Further, the full-screen refresh rate determination unit 115A determines an area to be refreshed at the high refresh rate and outputs the area to the readout area control unit 116 and the level shifter control signal generation unit 118. The full-screen refresh rate determination unit 115A outputs, to the readout area control unit 116, a region in the RAM 114 in which the partial area data is stored. Further, the full-screen refresh rate determination unit 115A outputs, to the level shifter control signal generation unit 118, position information (control gate bus line position information) of a gate bus line corresponding to the partial area.

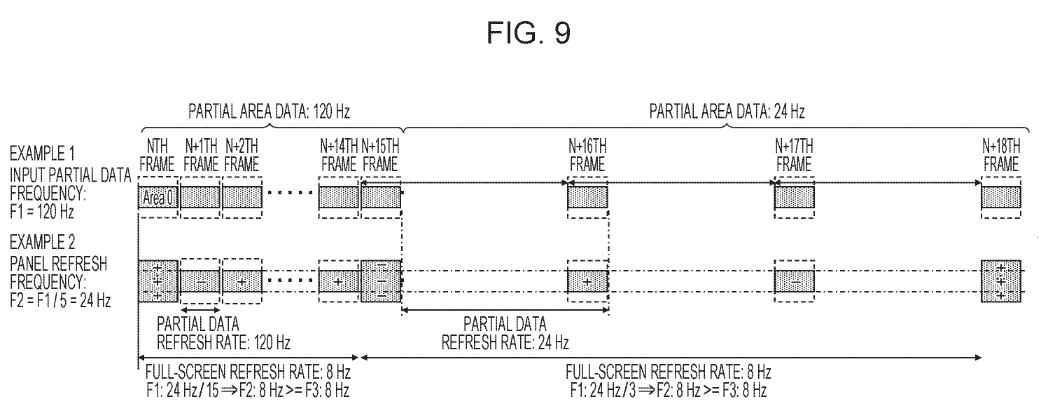

FIG. 9 is a diagram for explaining a polarity inversion driving method for the display device according to the embodiment of the present disclosure. FIG. 9 shows a case where the input frequency switches from 120 Hz to 24 Hz, and the display device operates at an input frequency of 120 Hz in the Nth to N+15th frames. In a case where the input frequency is 120 Hz, a full-screen refresh is performed in the Nth frame and the N+15th frame.

Further, in the N+16th and subsequent frames, the display device operates at an input frequency of 24 Hz. In a case where the input frequency is 24 Hz, a full-screen refresh is performed in the N+18th frame. In a case where the input frequency is 24 Hz, the maximum odd number is 3, and the frequency of the full-screen refresh rate is 8 Hz.

### Working Effects

As described above, the embodiment of the present disclosure brings about the following working effects.

In the display device 100, which uses a polarity inversion driving method in which the polarity of a source signal that is supplied to a source bus line is inverted every frame period, the full-screen refresh rate determination unit 115A of the control circuit 11A determines, as the full-screen refresh rate, a numerical value obtained as a result of dividing the input frequency by a maximum odd number that does not fall below the minimum refresh rate stored in the built-in register 121. This makes it possible to cause the frequency of the full-screen refresh rate to assume a value close to the minimum refresh rate, further reduce power consumption, and achieve driving in which a plurality of refresh rates are mixed, with display quality kept. The set value stored in the built-in register 121 is not limited to the frequency of the full-screen refresh rate but may be another predetermined frequency.

### Third Embodiment

In actuality, in a case where a display device is used as a notebook personal computer, there is a case where no video data comes from a system to a liquid crystal module. This is especially true not during a movie display but in the case of a still image display. During use of Office software or in a case where a picture such as a screen-saver is displayed, such a situation occurs, for example, in a period during which the user does not touch an input device such as a keyboard or a mouse.

In such a case, even a liquid crystal module in which a plurality of refresh rates can be mixed may be subjected to power consumption reduction by driving the entire screen at a fixed minimum frequency. Further, the frequency in that case may be set to a value (second refresh rate) that is smaller than the frequency of the minimum refresh rate (first minimum refresh rate) described in the second embodiment. This is intended to use the value of the second minimum refresh rate in driving in which a plurality of refresh rates are not able to be mixed.

### Example Configuration of Display Device

A display device according to an embodiment of the present disclosure differs only in control circuit configuration from the example configuration of the display device 100 according to the first embodiment. In the following description, the control circuit according to the present embodiment is denoted by reference sign 11B.

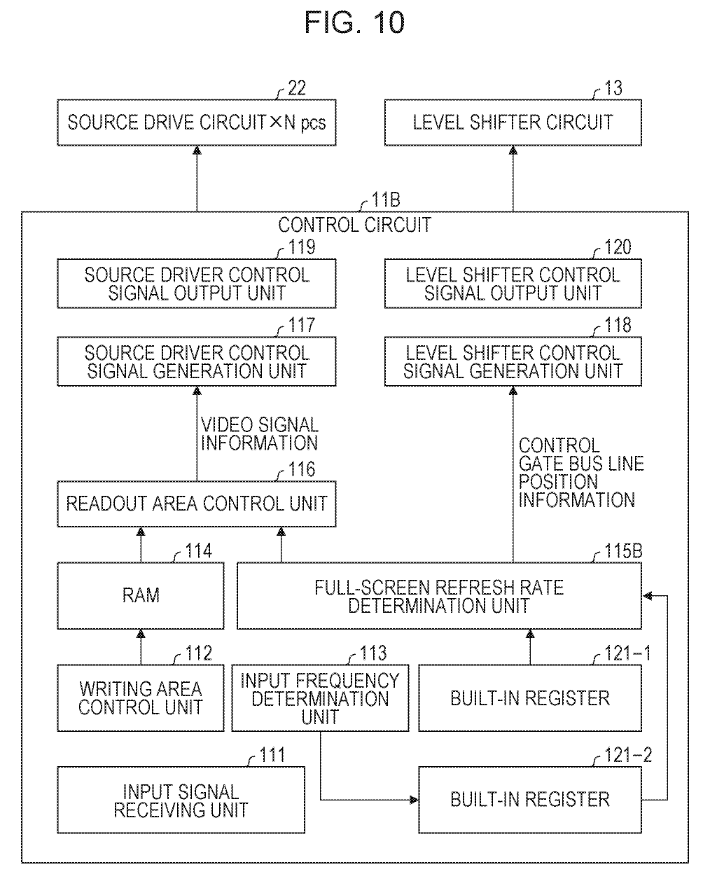

FIG. 10 is a block diagram showing an example configuration of the control circuit 11B of the display device 100 according to the embodiment of the present disclosure. As shown in FIG. 10, the control circuit 11B includes an input signal receiving unit 111, a writing area control unit 112, an input frequency determination unit 113, a RAM (random-access memory) 114, a full-screen refresh rate determination unit 115B, a readout area control unit 116, a source driver control signal generation unit 117, a level shifter control signal generation unit 118, a source driver control signal output unit 119, a level shifter control signal output unit 120, and built-in registers 121-1 and 121-2.

The built-in register 121-1 retains the set value of the minimum refresh rate. For example, the description assumes that 24 Hz is set as the set value of the minimum refresh rate in the built-in register 121-1.

Further, the built-in register 121-2 retains a value (second minimum refresh rate (second predetermined refresh rate)) that is smaller than the set value of the minimum refresh rate. For example, the description assumes that 4 Hz is set as the set value of the second minimum refresh rate in the built-in register 121-2.

The full-screen refresh rate determination unit 115B determines, as the full-screen refresh rate, a numerical value obtained as a result of dividing the input frequency by a maximum odd number that does not fall below the minimum refresh rate stored in the built-in register 121-1. In a case where the set value of the minimum refresh rate is 24 Hz, the maximum odd number is 5; therefore, the full-screen refresh rate determination unit 115B determines that the frequency of the full-screen refresh rate is 24 Hz.

Further, in a case where there is no input of screen data from the PC system side motherboard 3 for a predetermined period of time, the full-screen refresh rate determination unit 115B determines, as the frequency of the full-screen refresh rate, the value of the second minimum refresh rate stored in the built-in register 121-2. In this case, there is no need for refresh at the high refresh rate, so that only a refresh operation at the full-screen refresh rate is performed.

### Working Effects

As described above, the embodiment of the present disclosure brings about the following working effects.

In the display device 100, which uses a polarity inversion driving method in which the polarity of a source signal that is supplied to a source bus line is inverted every frame period, in a case where there is no input of screen data from the PC system side motherboard 3 for a predetermined period of time, the full-screen refresh rate determination unit 115B of the control circuit 11B determines, as the frequency of the full-screen refresh rate, the value of the second minimum refresh rate stored in the built-in register 121-1. This makes it possible to lower the frequency of the full-screen refresh rate in a case where there is no input of screen data from the PC system side motherboard 3 for a predetermined period of time and to further reduce power consumption.

### Modification

Instead of retaining a value that is smaller than the minimum refresh rate (first minimum refresh rate) retained by the built-in register 121-1, the built-in register 121-2 may retain a set value of the same value (second minimum refresh rate (second predetermined refresh rate)) as the minimum refresh rate (first minimum refresh rate) retained by the built-in register 121-1. For example, 4 Hz is set as the set value of the second minimum refresh rate in the built-in register 121-2.

Further, in a case where there is no input of screen data from the PC system side motherboard 3 for a predetermined period of time, the full-screen refresh rate determination unit 115B determines, as the frequency of the full-screen refresh rate, the value of the second minimum refresh rate stored in the built-in register 121-2. In this case, there is no need for refresh at the high refresh rate, so that only a refresh operation at the full-screen refresh rate is performed.

Even this modification makes it possible to lower the frequency of the full-screen refresh rate in a case where there is no input of screen data from the PC system side motherboard 3 for a predetermined period of time and to reduce power consumption.

In the case of the modification, the control circuit 11B may be configured to omit the built-in register 121-2, and in a case where there is no input of screen data from the PC system side motherboard 3 for a predetermined period of time, the full-screen refresh rate determination unit 115B may determine, as the frequency of the full-screen refresh rate, the value of the minimum refresh rate stored in the built-in register 121-1.

### Conclusion

The present disclosure describes at least the following aspects.

### Aspect 1

A display device according to Aspect 1 of the present disclosure includes a display panel including a pixel electrode and a common electrode that forms an electric field with the pixel electrode, a gate drive circuit that supplies a gate signal to a gate bus line of the display panel, a source drive circuit that supplies a pixel voltage to the pixel electrode by sequentially supplying a source signal to a source bus line of the display panel, and a control circuit that controls a refresh rate that is a frequency at which an image displayed on the display panel is rewritten. The source drive circuit effects alternate current driving of a polarity of a source signal that is supplied to the source bus line. The control circuit controls the gate drive circuit and the source drive circuit so that in a partial area, the pixel voltage is supplied at a first refresh rate and so that in an area other than the partial area, the pixel voltage is supplied at a second refresh rate that is lower than the first refresh rate and that is a frequency of a fraction of an odd number-th of the first refresh rate.

### Aspect 2

A display device according to Aspect 2 of the present disclosure includes a display panel including a pixel electrode and a common electrode that forms an electric field with the pixel electrode, a gate drive circuit that supplies a gate signal to a gate bus line of the display panel, a source drive circuit that supplies a pixel voltage to the pixel electrode by sequentially supplying a source signal to a source bus line of the display panel, and a control circuit that controls a refresh rate that is a frequency at which an image displayed on the display panel is rewritten. The source drive circuit effects alternate current driving of a polarity of a source signal that is supplied to the source bus line. The control circuit controls the gate drive circuit and the source drive circuit so that in a partial area, the pixel voltage is supplied at a first refresh rate and so that in an area other than the partial area, the pixel voltage is supplied at a second refresh rate that is lower than the first refresh rate and at which a polarity of the source signal is subjected to alternate current driving.

### Aspect 3

A display device according to Aspect 3 of the present disclosure is directed to Aspect 2, wherein the second refresh rate is a frequency of a fraction of an odd number-th of the first refresh rate.

### Aspect 4

A display device according to Aspect 4 of the present disclosure is directed to any of Aspects 1 to 3, further including a first register in which to store a first predetermined refresh rate. The control circuit sets, as the second refresh rate, a numerical value obtained as a result of dividing a frequency of the first refresh rate by a maximum odd number that does not fall below the first predetermined refresh rate.

### Aspect 5

A display device according to Aspect 5 of the present disclosure is directed to Aspect 4, further including a second register in which to store a second predetermined refresh rate. In a case where there is no input of image data from an outside source, the control circuit sets, as a frequency of the second refresh rate, the second predetermined refresh rate stored in the second register.

### Aspect 6

A display device according to Aspect 6 of the present disclosure is directed to Aspect 4, further including a second register in which to store a second predetermined refresh rate. In a case where there is no input of image data from an outside source, the control circuit sets, as a frequency that is lower than a frequency of the second refresh rate, the second predetermined refresh rate stored in the second register.

### Aspect 7

A method according to Aspect 7 of the present disclosure for driving a display device is a method for driving the display device according to any of Aspects 1 to 3.

### Aspect 8

An electronic apparatus according to Aspect 8 of the present disclosure includes the display device according to any of Aspects 1 to 3 and a motherboard that supplies the display device with image data corresponding to the partial area and image data corresponding to an entire screen.

The present disclosure is not limited to the embodiments described above. but may be variously altered within the scope of the claims, and an embodiment based on a proper combination of technical means disclosed in different embodiments is encompassed in the technical scope of the present disclosure.

The present disclosure contains subject matter related to that disclosed in Japanese Priority Patent Application JP 2025-059658 filed in the Japan Patent Office on March 31, 2025, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device comprising:
a display panel including a pixel electrode and a common electrode that forms an electric field with the pixel electrode;
a gate drive circuit that supplies a gate signal to a gate bus line of the display panel;
a source drive circuit that supplies a pixel voltage to the pixel electrode by sequentially supplying a source signal to a source bus line of the display panel; and
a control circuit that controls a refresh rate that is a frequency at which an image displayed on the display panel is rewritten,
wherein
the source drive circuit effects alternate current driving of a polarity of a source signal that is supplied to the source bus line, and
the control circuit controls the gate drive circuit and the source drive circuit so that in a partial area, the pixel voltage is supplied at a first refresh rate and so that in an area other than the partial area, the pixel voltage is supplied at a second refresh rate that is lower than the first refresh rate and that is a frequency of a fraction of an odd number-th of the first refresh rate.

2. A display device comprising:
a display panel including a pixel electrode and a common electrode that forms an electric field with the pixel electrode;
a gate drive circuit that supplies a gate signal to a gate bus line of the display panel;
a source drive circuit that supplies a pixel voltage to the pixel electrode by sequentially supplying a source signal to a source bus line of the display panel; and
a control circuit that controls a refresh rate that is a frequency at which an image displayed on the display panel is rewritten,
wherein
the source drive circuit effects alternate current driving of a polarity of a source signal that is supplied to the source bus line, and
the control circuit controls the gate drive circuit and the source drive circuit so that in a partial area, the pixel voltage is supplied at a first refresh rate and so that in an area other than the partial area, the pixel voltage is supplied at a second refresh rate that is lower than the first refresh rate and at which a polarity of the source signal is subjected to alternate current driving.

3. The display device according to claim 2, wherein the second refresh rate is a frequency of a fraction of an odd number-th of the first refresh rate.

4. The display device according to claim 1, further comprising a first register in which to store a first predetermined refresh rate,
wherein the control circuit sets, as the second refresh rate, a numerical value obtained as a result of dividing a frequency of the first refresh rate by a maximum odd number that does not fall below the first predetermined refresh rate.

5. The display device according to claim 4, further comprising a second register in which to store a second predetermined refresh rate,
wherein in a case where there is no input of image data from an outside source, the control circuit sets, as a frequency of the second refresh rate, the second predetermined refresh rate stored in the second register.

6. The display device according to claim 4, further comprising a second register in which to store a second predetermined refresh rate,
wherein in a case where there is no input of image data from an outside source, the control circuit sets, as a frequency that is lower than a frequency of the second refresh rate, the second predetermined refresh rate stored in the second register.

7. A method for driving the display device according to claim 1.

8. An electronic apparatus comprising:
the display device according to claim 1; and
a motherboard that supplies the display device with image data corresponding to the partial area and image data corresponding to an entire screen.
